(19) United States
(12) Patent Application Publication
(10) Pub. No.: US 2022/0056758 A1
(43) Pub. Date: Feb. 24, 2022

(54) ROLLER-SHUTTER-TYPE GUARDRAIL

(71) Applicant: Zhongshan Ekar Uping Houseware Co., Ltd., Zhongshan City (CN)

(72) Inventors: JiangHua HE, Zhongshan City (CN); GuoZhu FENG, Zhongshan City (CN); XinLiang OUYANG, Zhongshan City (CN)

(21) Appl. No.: 17/123,717

(22) Filed: Dec. 16, 2020

(30) Foreign Application Priority Data
Aug. 21, 2020 (CN) 202021772838.X

(51) Int. Cl. E06B 9/172; E06B 9/17

(52) U.S. Cl. CPC E06B 9/172; E06B 9/17007; E06B 2009/002; E06B 9/17061; E06B 9/17046

(57) ABSTRACT

Disclosed is a roller-shutter-type guardrail, which includes: a shutter fixing seat provided with an insertion hole; and a shutter assembly, the roller shutter assembly including a shutter mounting seat, a rotating shaft being rotatably mounted on the roller shutter mounting seat, the rotating shaft being provided with a shutter cloth, a connecting member being arranged on a free end of the shutter cloth, and the shutter mounting seat being provided with a locking mechanism for limiting or releasing rotation of the rotating shaft.

### CROSS-REFERENCE TO RELATED APPLICATION

This application claims priority to Chinese patent application No. 202021772838.X, filed Aug. 21, 2020, which is incorporated by reference herein in its entirety.

### TECHNICAL FIELD

The present disclosure relates to the field of protection, and more particularly, to a roller-shutter-type guardrail.

### BACKGROUND

In order to prevent a child from accessing certain areas, people usually set up guardrails at entrances of the certain areas, thus achieving the purpose of restricting the child from accessing the certain areas.

However, since an existing guardrail is generally made of a rigid material, the child is easily injured when colliding with the guardrail. Moreover, the existing guardrail cannot be folded and is large in volume, which is inconvenient to transport and store.

### SUMMARY

The present disclosure is intended to solve at least one of the technical problems in the existing technology. For this purpose, the present disclosure provides a roller-shutter-type guardrail, which not only can reduce a harm to a child when the child collides with the guardrail, but also can reduce a volume of the guardrail, which is convenient to transport and store.

The following technical solutions are used in the present disclosure to solve the above technical problems.

A roller-shutter-type guardrail according to some embodiments of the present disclosure includes: a shutter fixing seat, the shutter fixing seat being provided with an insertion hole; and a shutter assembly, the shutter assembly including a shutter mounting seat, a rotating shaft being rotatably mounted on the shutter mounting seat, the rotating shaft being provided with a shutter cloth capable of being rolled up or unrolled, and a connecting member capable of being matched with the insertion hole being arranged on a free end of the shutter cloth, wherein the roller shutter mounting seat is provided with a locking mechanism for limiting rotation of the rotating shaft or releasing rotation of the rotating shaft.

In some embodiments of the present disclosure, the shutter mounting seat is provided with an accommodating cavity with an opening, a bottom wall of the accommodating cavity is provided with a mounting hole, and one end of the rotating shaft passes through the mounting hole and extends into the accommodating cavity; the locking mechanism includes: a clamping tooth portion, the clamping tooth portion being arranged on an inside wall of the accommodating cavity; a clamping member, an outer periphery of the clamping member being provided with a first clamping tooth capable of being clamped with the clamping tooth portion, the clamping member being movably sleeved on one end of the rotating shaft extending into the accommodating cavity, the clamping member being capable of moving along an axial direction of the rotating shaft, and a limiting structure being arranged between the clamping member and the rotating shaft for limiting the clamping member to rotate around a central axis of the rotating shaft; an elastic member sleeved on an outer peripheral wall of the rotating shaft, one end of the elastic member abutting against the bottom wall of the accommodating cavity, and the other end of the elastic member abutting against the clamping member; and a force-applying member, the force-applying member being movably mounted at the opening of the accommodating cavity, the force-applying member being capable of exerting a force on the clamping member and pushing the clamping member to be clamped with the clamping tooth portion.

In some embodiments of the present disclosure, the limiting structure includes a clamping slot and a clamping block which are capable of being clamped with each other; and one of the clamping slot and the clamping block is arranged on a side wall of the rotating shaft, and the other is arranged on the clamping member.

In some embodiments of the present disclosure, the shutter assembly further includes a hollow cylinder, the hollow cylinder is movably sleeved on an outer periphery of the rotating shaft, a space for accommodating the shutter cloth is left between the cylinder and the rotating shaft, a side wall of the cylinder is provided with an opening for the shutter cloth to pass through, one end of the cylinder is provided with a locking portion movably passing through the mounting hole and extending into the accommodating cavity, the locking portion is provided with a locking tooth, and the clamping member is provided with a second clamping tooth capable of being engaged with or separated from the locking tooth.

In some embodiments of the present disclosure, one end of the shutter mounting seat connected with a mounting plane is detachably connected with a base, the base is provided with an insertion slot, and the shutter mounting seat is provided with an insertion plate capable of being inserted into the insertion slot.

In some embodiments of the present disclosure, a positioning structure is arranged between the shutter mounting seat and the base to limit horizontal movement and separation of the shutter mounting seat and the base.

In some embodiments of the present disclosure, the positioning structure includes a bolt movably mounted on a bottom portion of the shutter mounting seat and a bolt hole arranged in a surface of the base; and an elastic pushing member capable of pushing the bolt to move towards an exterior of the shutter mounting seat is arranged inside the shutter mounting seat, and the shutter mounting seat is also provided with a pushing structure capable of enabling the bolt to retract and move towards an interior of the shutter mounting seat.

In some embodiments of the present disclosure, the pushing structure includes: a linking member movably mounted inside the shutter mounting seat, the linking member being connected with the bolt, and the linking member being provided with an inclined guide plane; and a pressing member movably mounted inside the shutter mounting seat, one end of the pressing member extending out of the shutter mounting seat, and the other end of the pressing member being capable of pressing the inclined guide surface and enabling the linkage member to drive the bolt to retract and move towards the interior of the shutter mounting seat synchronously.

In some embodiments of the present disclosure, two shutter fixing seats are provided, and two ends of the connecting member are inserted into the insertion holes of the two shutter fixing seats in one-to-one correspondence.

In some embodiments of the present disclosure, one end of the connecting member is provided with a movable ejector head capable of extending outwardly or retracting inwardly, and the movable ejector head is inserted into the insertion hole of one of the shutter fixing seats; and a pushing member is movably mounted on the shutter fixing seat with the movable ejector head inserted, one end of the pushing member extends out of the shutter fixing seat, and the other end of the pushing member extends into the insertion hole.

The above embodiments of the present disclosure have the beneficial effects that: by setting the guardrail to be composed of the shutter fixing seat and the shutter assembly, when in use, the shutter fixing seat and the shutter assembly may be correspondingly mounted at an entrance, and meanwhile, the shutter cloth is pulled to be unrolled and connected with the shutter fixing seat. At the moment, the shutter cloth may block the entrance, thereby restricting children from entering. Moreover, since the shutter cloth is made of a soft material, even if the child collides with the shutter cloth, a harm to the child can be greatly reduced, thus ensuring a personal safety of the child, and when the entrance needs to be opened, the shutter cloth may be rolled up to open the entrance by disconnecting the shutter cloth with the shutter fixing seat only, thereby being convenient to use. Moreover, the rolled up shutter assembly is small in volume, thereby being convenient to transport and store.

### BRIEF DESCRIPTION OF THE DRAWINGS

The present disclosure is further described in detail hereinafter with reference to the accompanying drawings and the specific embodiments.

FIG. 1 is a structure diagram of a roller-shutter-type guardrail in a use state according to a certain embodiment of the present disclosure;

FIG. 2 is an exploded view of a local structure of a shutter assembly in the roller-shutter-type guardrail shown in FIG. 1;

FIG. 3 is a cross-sectional view of an assembly structure of a shutter mounting seat and a rotating shaft in the roller-shutter-type guardrail shown in FIG. 1;

FIG. 4 is an exploded view of an assembly structure of a connecting member and a shutter fixing seat in the roller-shutter-type guardrail shown in FIG. 1;

FIG. 5 is a cross-sectional view of the assembly structure of the connecting member and the shutter fixing seat in the roller-shutter-type guardrail shown in FIG. 1;

FIG. 6 is a schematic diagram of an assembly structure of the shutter mounting seat and a base in the roller-shutter-type guardrail shown in FIG. 1;

FIG. 7 is an exploded view of the assembly structure of the shutter mounting seat and the base in the roller-shutter-type guardrail shown in FIG. 1;

FIG. 8 is a part drawing of the shutter mounting seat in the roller-shutter-type guardrail shown in FIG. 1;

FIG. 9 is a cross-sectional view of the assembly structure of the shutter mounting seat and the base in the roller-shutter-type guardrail shown in FIG. 1; and

FIG. 10 is an enlarged view of a part A in FIG. 2.

### DETAILED DESCRIPTION

This part will describe the specific embodiments of the present disclosure in detail, and the preferred embodiments of the present disclosure are shown in the accompanying drawings. The accompanying drawings are used to supplement the description of the text in the specification with the graphs, so that people can intuitively and vividly understand each technical feature and the overall technical solution of the present disclosure, but the accompanying drawings cannot be understood as limiting the scope of protection of the present disclosure.

In the description of the present disclosure, it shall be understood that the orientation or position relationship indicated by the terms up, down, front, rear, left, right, and the like is based on the orientation or position relationship shown in the accompanying drawings, it is only for the convenience of description of the present disclosure and simplification of the description, and it is not to indicate or imply that the indicated device or element must have a specific orientation, and be constructed and operated in a specific orientation. Therefore, the terms shall not be understood as limiting the present disclosure.

In the description of the present disclosure, the meaning of several refers to be one or more, and the meaning of multiple refers to be more than three. The meanings of greater than, less than, more than, and the like are understood as not including this number, while the meanings of above, below, within, and the like are understood as including this number. If the terms first, second and the like are used for the purpose of distinguishing the technical features only in the description, and cannot be understood as indicating or implying relative importance, implicitly indicating the number of technical features indicated thereby, or implicitly indicating the order of technical features indicated thereby.

In the description of the present disclosure, the terms arrangement, installation, connection and the like shall be understood in broad sense unless otherwise specified and defined. The specific meaning of the above terms in the present disclosure may be reasonably determined according to specific contents of the technical solutions by those skilled in the art.

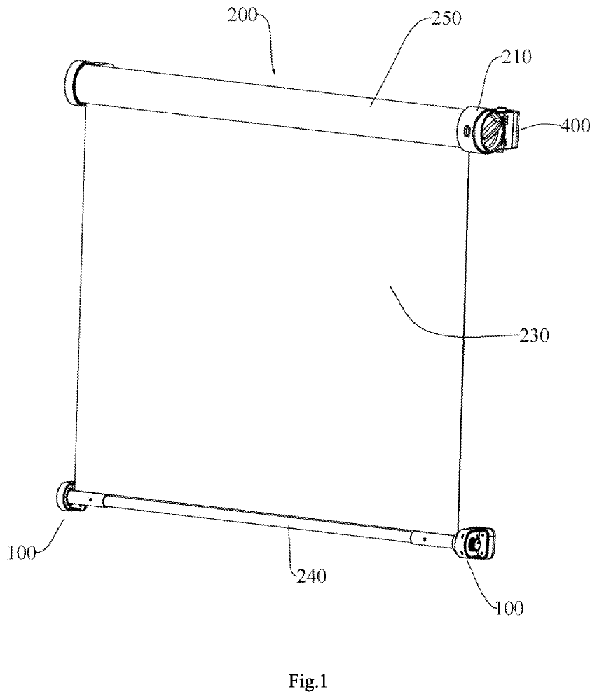

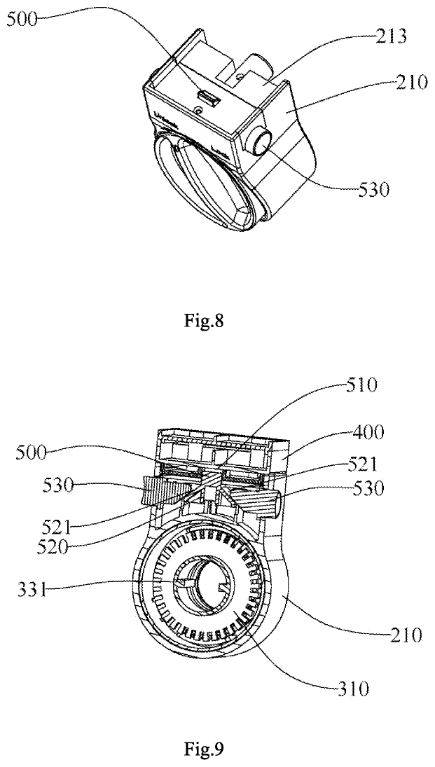

Referring to FIG. 1 to FIG. 10, a roller-shutter-type guardrail according to some embodiments of the present disclosure includes a shutter fixing seat 100 and a shutter assembly 200. The shutter fixing seat 100 and the shutter assembly 200 may be mounted on a door frame or a wall at an entrance, and the shutter fixing seat 100 is provided with an insertion hole 110. The shutter assembly 200 includes a shutter mounting seat 210, a rotating shaft 220 is rotatably mounted on the shutter mounting seat 210, the rotating shaft 220 is provided with a shutter cloth 230 capable of being rolled up or unrolled, and a connecting member 240 capable of being matched with the insertion hole 110 is arranged on a free end of the shutter cloth 230. The roller shutter mounting seat 210 is provided with a locking mechanism for limiting rotation of the rotating shaft 220 or releasing rotation of the rotating shaft 220. The locking mechanism may limit the rotation of the rotating shaft 220, so that the shutter cloth 230 may be prevented from being unrolled when not in use, and the locking mechanism may also release the rotation of the rotating shaft 220 when the shutter cloth is needed, so that a user can unroll the shutter cloth 230 conveniently, thereby meeting needs of the user.

By setting the guardrail to be composed of the shutter fixing seat 100 and the shutter assembly 200, when in use, the shutter fixing seat 100 and the shutter assembly 200 may be correspondingly mounted at an entrance, and meanwhile, the shutter cloth 230 is pulled to be unrolled and connected with the shutter fixing seat 100. At the moment, the shutter cloth 230 may block the entrance, so as to restrict accessing of a child. Moreover, since the shutter cloth 230 is made of a soft material, even if the child collides with the shutter cloth 230, a harm to the child can be greatly reduced, thus ensuring a personal safety of the child, and when the entrance needs to be opened, the shutter cloth 230 can be rolled up to open the entrance by disconnecting the shutter cloth 230 with the shutter fixing seat 100 only, thus being convenient to use. Moreover, the shutter assembly 200 rolled up is small in volume, which is convenient to transport and store.

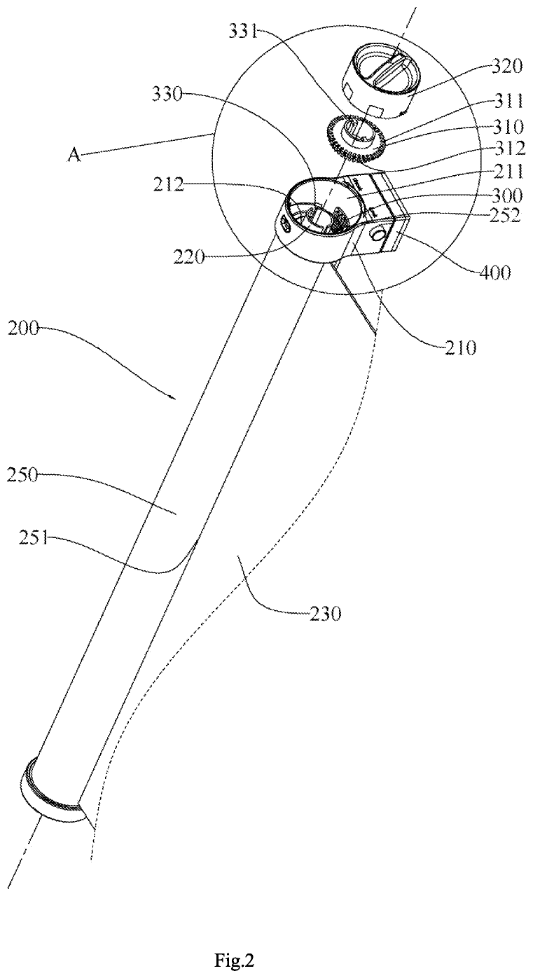

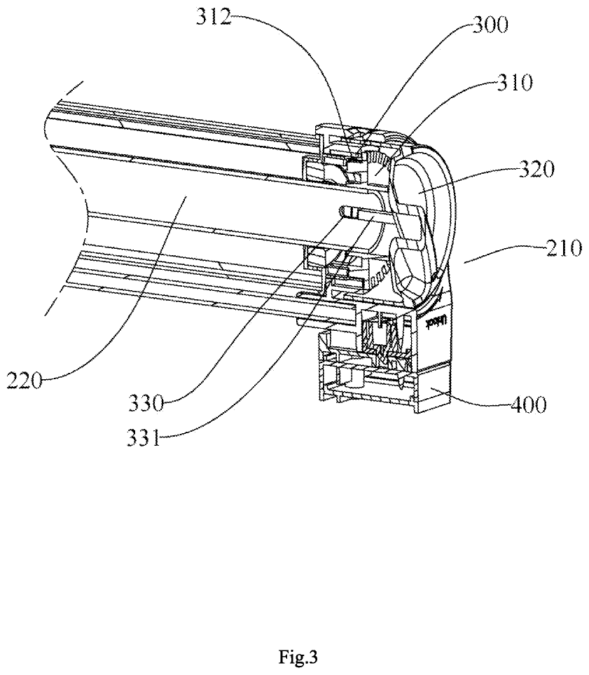

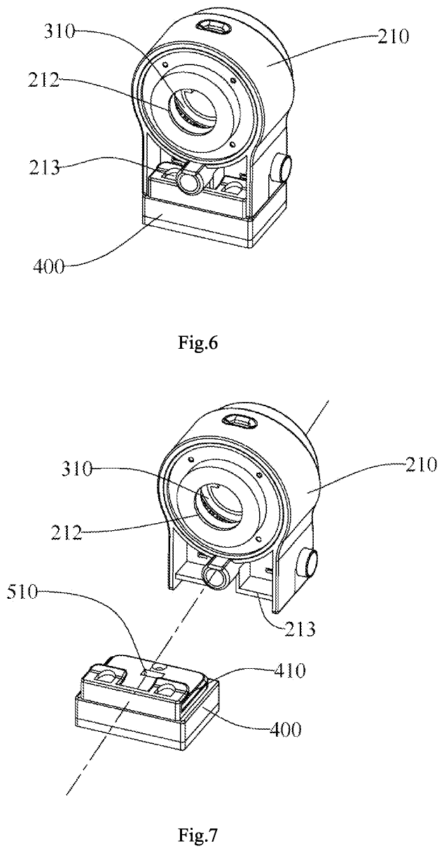

Referring to FIG. 2, FIG. 3 and FIG. 6, in order to simplify a structure of the shutter assembly 200, in some embodiments of the present disclosure, the shutter mounting seat 210 is provided with an accommodating cavity 211 with an opening, a bottom wall of the accommodating cavity 211 is provided with a mounting hole 212, and one end of the rotating shaft 220 passes through the mounting hole 212 and extends into the accommodating cavity 211. The locking mechanism includes a clamping tooth portion 300, a clamping member 310, an elastic member (not shown in the drawings) and a force-applying member 320. The clamping tooth portion 300 is arranged on an inside wall of the accommodating cavity 211. An outer periphery of the clamping member 310 is provided with a first clamping tooth 311 capable of being clamped with the clamping tooth portion 300, the clamping member 310 is movably sleeved on one end of the rotating shaft 220 extending into the accommodating cavity 211, the clamping member 310 is capable of moving along an axial direction of the rotating shaft 220, and a limiting structure is arranged between the clamping member 310 and the rotating shaft 220 for limiting the clamping member 310 to rotate around a central axis of the rotating shaft 220. The elastic member is sleeved on an outer peripheral wall of the rotating shaft 220, one end of the elastic member abuts against the bottom wall of the accommodating cavity 211, and the other end of the elastic member abuts against the clamping member 310. In the embodiment, the elastic member may be a compression spring or a column made of silica gel or rubber. The force-applying member 320 is movably mounted at the opening of the accommodating cavity 211, the force-applying member 320 is capable of exerting a force on the clamping member 310 and pushing the clamping member 310 to be clamped with the clamping tooth portion 300. The above force-applying member 320 may be connected with the accommodating cavity 211 through a thread. When the user rotates the force-applying member 320, the force-applying member 320 may be screwed into the accommodating cavity 211. At the moment, the force-applying member 320 pushes the clamping member 310 to move and enables the first clamping tooth 311 to be clamped with the clamping tooth portion 300, and the rotating shaft 220 cannot be rotated. At the moment, the above shutter cloth 230 cannot be unrolled or rolled up. When the user reversely rotates the force-applying member 320, the force-applying member 320 is screwed out of the accommodating cavity 211. At the moment, the force-applying member 320 no longer presses the clamping member 310, the clamping member 310 moves away from the clamping tooth portion 300 under a thrust force of the elastic member, and the rotating shaft 220 can be rotated. At the moment, the above shutter cloth 230 can be unrolled or rolled up. Use of the above structure can greatly simplify the structure of the shutter assembly 200, thereby the structure of the shutter assembly 200 being convenient to produce and manufacture.

It is conceivable that the force-applying member 320 may also have other structures except for connection with the accommodating cavity 211 through the thread For example, the force-applying member 320 is movably mounted in the accommodating cavity 211, the side wall of the accommodating cavity 211 is provided with a bolt (not shown in the drawings) arranged along a radial direction of the rotating shaft 220, and after the user exerts a force to press the force-applying member 320 to move towards an interior of the accommodating cavity 211, the bolt may be screwed to extend into the accommodating cavity 211 along the side wall of the accommodating cavity 211. At the moment, the bolt restricts the force-applying member 320 from coming out of the accommodating cavity 211, so that the force-applying member 320 may press the clamping member 310 to be clamped with the clamping tooth portion 300. When released, the force-applying member 320 may come out of the accommodating cavity 211 only by reversely screwing the bolt to come out of the accommodating cavity 211. At the moment, the clamping member 310 may be separated from the clamping tooth portion 300 under an action of the elastic member.

In order to ensure synchronous rotation of the connecting member 310 and the rotating shaft 220, in some embodiments of the present disclosure, the limiting structure includes a clamping slot 330 and a clamping block 331 which are capable of being clamped with each other. One of the clamping slot 330 and the clamping block 331 is arranged on a side wall of the rotating shaft 220, and the other is arranged on the clamping member 310. Specifically, the clamping slot 330 is arranged on the side wall of the rotating shaft 220, and the clamping block 331 is arranged on an inner wall of the clamping member 310. Certainly, it is also available that the clamping slot 330 is arranged on the inner wall of the clamping member 310 and the clamping block 331 is arranged on the side wall of the rotating shaft 220. The details may be determined according to actual needs.

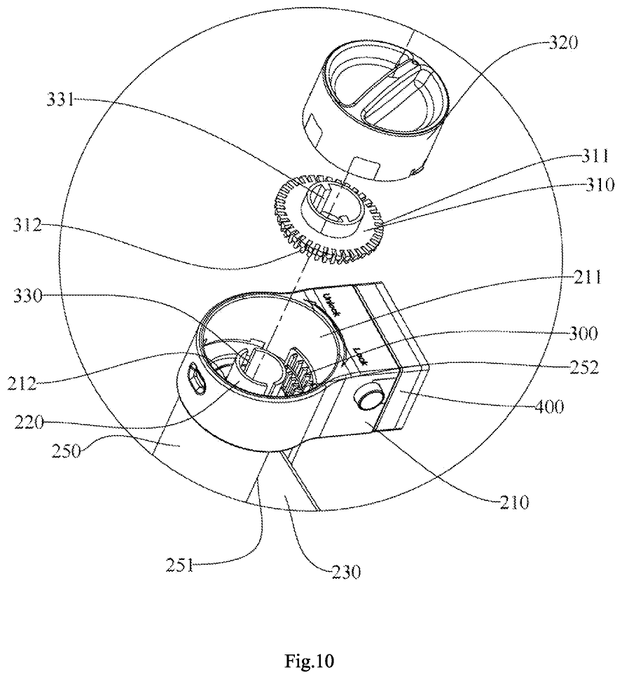

Referring to FIG. 1, FIG. 2 and FIG. 10, in order to make an appearance of the guardrail of the present disclosure more beautiful and protect the shutter cloth 230 at the same time, in some embodiments of the present disclosure, the shutter assembly 200 further includes a hollow cylinder 250. The hollow cylinder 250 is movably sleeved on an outer periphery of the rotating shaft 220, a space for accommodating the shutter cloth 230 is left between the cylinder 250 and the rotating shaft 220, and a side wall of the cylinder 250 is provided with an opening 251 for the shutter cloth 230 to pass through, so that the shutter cloth 230 is wound on an outer peripheral wall of the rotating shaft 220 is located inside the cylinder 250. At the moment, the cylinder 250 covers an outer periphery of the shutter cloth 230. When the shutter cloth 230 needs to be unrolled, the shutter cloth 230 only needs to be pulled and then the shutter cloth 230 passes through the opening 251 and spreads outwardly, which is simple and convenient. When the shutter cloth 230 is not needed, the shutter cloth 230 may be rolled up back into the cylinder 250 from the opening 251, which is simple and convenient. Use of the above structure may prevent foreign objects from being contacted with the shutter cloth 230, thereby protecting the shutter cloth 230, and making the guardrail of the present disclosure more beautiful in appearance at the same time.

Further, in order to facilitate the user to regulate an orientation of the shutter cloth 230 when the shutter cloth spreads outwardly, in some embodiments of the present disclosure, one end of the cylinder 250 is provided with a locking portion movably passing through the mounting hole 212 and extending into the accommodating cavity 211. The locking portion is provided with a locking tooth 252, and the clamping member 310 is provided with a second clamping tooth 312 capable of being engaged with or separated from the locking tooth 252. When the locking mechanism unlocks the rotating shaft 220, the elastic member pushes the clamping member 310 to move away from the clamping tooth portion 300. At the moment, the second clamping tooth 312 on the clamping member 310 is also separated from the locking tooth 252, and the clamping member 310 is no longer clamped with a locking portion at an end portion of the cylinder 250, so that the cylinder 250 may be rotated relative to the mounting hole 212. The user may freely rotate the cylinder 250 to regulate an orientation of the opening 251 as needed, and then regulates the orientation of the shutter cloth 230 when the shutter cloth spreads outwardly at will. After the user pulls the shutter cloth 230 to extend outwardly for a sufficient length, the user may screw the force-applying member 320 to press the clamping member 310 to move closer to the clamping tooth portion 300. When the first clamping tooth 311 of the clamping member 310 is clamped with the clamping tooth portion 300, the second clamping tooth 312 on the clamping member 310 is also engaged and clamped with the locking tooth 252. At the moment, the clamping member 310 locks the rotating shaft 220 and the cylinder 250 synchronously. At the moment, the rotating shaft 220 and the cylinder 250 cannot be rotated, which ensures that the length and the orientation of the shutter cloth 230 are fixed, thus meeting needs of the user. When the user needs to roll up the shutter cloth 230 or regulate the orientation of the shutter cloth 230, locking of the rotating shaft 220 and the cylinder 250 by the connecting member 310 needs to be released only, which is simple and convenient.

Referring to FIG. 6 to FIG. 9, in order to facilitate mounting of the shutter assembly 200 on the door frame or the wall, in some embodiments of the present disclosure, one end of the shutter mounting seat 210 connected with a mounting plane is detachably connected with a base 400, the base 400 is provided with an insertion slot 410, and the shutter mounting seat 210 is provided with an insertion plate 213 capable of being inserted into the insertion slot 410. The base 400 may be fixedly mounted on the door frame or the wall during mounting first during mounting, and then the insertion plate 213 of the shutter mounting seat 210 is correspondingly inserted into the insertion slot 410 of the base 400, which means that the shutter mounting seat 210 is completely mounted, thereby greatly facilitating mounting of the shutter assembly 200.

Further, in order to prevent the insertion board 213 from accidentally coming out of the insertion slot 410, in some embodiments of the present disclosure, a positioning structure is arranged between the shutter mounting seat 210 and the base 400 to limit horizontal movement and separation of the shutter mounting seat and the base. Specifically, the positioning structure includes a bolt 500 movably mounted on a bottom portion of the shutter mounting seat 210 and a bolt hole 510 arranged in a surface of the base 400. An elastic pushing member (not shown in the drawings) capable of pushing the bolt 500 to move towards an exterior of the shutter mounting seat 210 is arranged inside the shutter mounting seat 210, the elastic pushing member may be a compression spring or a column made of silica gel or rubber, and the shutter mounting seat 210 is also provided with a pushing structure capable of enabling the bolt 500 to retract and move towards an interior of the shutter mounting seat 210. The pushing structure includes: a linking member 520 and a pressing member 530. The linking member 530 is movably mounted inside the shutter mounting seat 210, the linking member 520 is connected with the bolt 500, and the linking member 520 is provided with an inclined guide plane 521. The pressing member 530 is movably mounted inside the shutter mounting seat 210, one end of the pressing member 530 extends out of the shutter mounting seat 210, and the other end of the pressing member 530 is capable of pressing the inclined guide surface 521 and enables the linkage member 520 to drive the bolt 500 to retract and move towards the interior of the shutter mounting seat 210 synchronously. Arrangement of the positioning structure between the shutter mounting seat 210 and the base 400 may prevent the shutter mounting seat 210 from horizontally moving and separating from the base 400, so that the shutter mounting seat 210 may be firmly mounted on the base 400, and the shutter assembly 200 is ensured to be mounted firmly and reliably.

In order to make the pushing structure better drive the bolt 500 to retract and move towards the interior of the shutter mounting seat 210, specifically, two inclined guide surfaces 521 are provided, and the two inclined guide surfaces 521 are correspondingly arranged on both sides of the linking member 520. Two pressing members 530 are provided, and the two pressing members 530 are arranged on one sides of the two inclined guide surfaces 521 in one-to-one correspondence. The user may press the two pressing members 530 at the same time and enable the pressing members 530 to retract and move towards the interior of the shutter mounting seat 210 in use, and then the pressing members 530 drive the linking members 520, so as to drive the bolt 500 to retract and move towards the interior of the shutter mounting seat 210 synchronously.

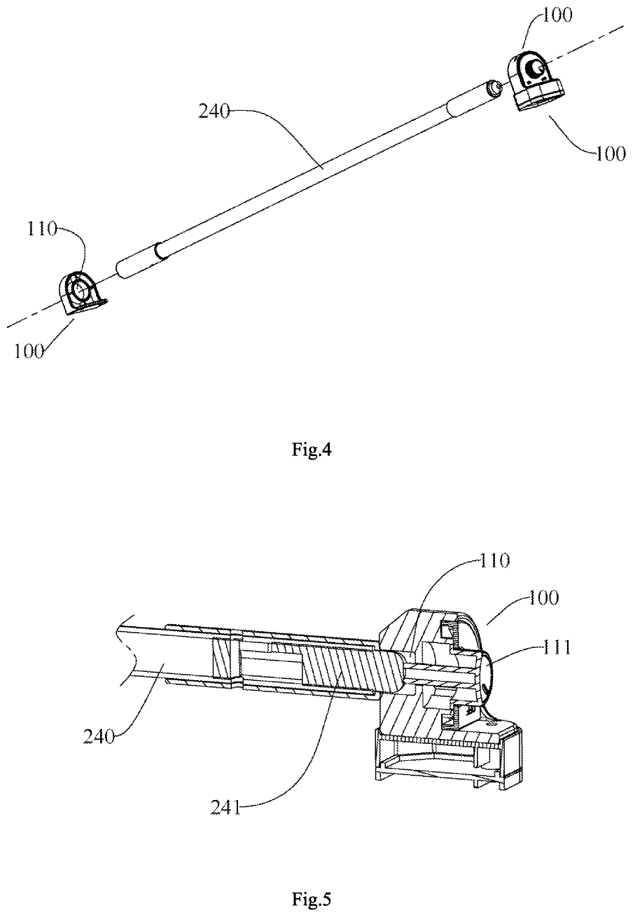

Referring to FIG. 1, FIG. 4 and FIG. 5, further, in order to make the shutter cloth 230 better connected with the shutter fixing seat 100, in some embodiments of the present disclosure, two shutter fixing seats 100 are provided, and two ends of the connecting member 240 are inserted into the insertion holes 110 of the two shutter fixing seats 100 in one-to-one correspondence. Use of the above structure enables connection between the shutter cloth 230 and the shutter fixing seat 100 to be more firmly and reliably.

In order to facilitate the connecting member 240 to come out of the shutter fixing seat 100, in some embodiments of the present disclosure, one end of the connecting member 240 is provided with a movable ejector head 241 capable of extending outwardly or retracting inwardly, and the movable ejector head 241 is inserted into the insertion hole 110 of one of the shutter fixing seats 100. A pushing member 120 is movably mounted on the shutter fixing seat 100 with the movable ejector head 241 inserted, one end of the pushing member 120 extends out of the shutter fixing seat 100, and the other end of the pushing member extends into the insertion hole 110. The user may press the pushing member 120 to move into the insertion hole 110 in use. At the moment, the pushing member 120 may push the movable ejector head 241 to come out of the insertion hole 110, so as to disconnect the connecting member 240 with the shutter fixing seat 100, thus facilitating the user to roll up the above shutter cloth 230.

The embodiments of the present disclosure are described in detail with reference to the accompanying drawings above, but the present disclosure is not limited to the above embodiments, and various changes may also be made within the knowledge scope of those of ordinary skills in the art without departing from the purpose of the present disclosure.

What is claimed is:

1. A roller-shutter-type guardrail, comprising:
a shutter fixing seat, the shutter fixing seat being provided with an insertion hole; and
a shutter assembly, the shutter assembly comprising a shutter mounting seat, a rotating shaft being rotatably mounted on the shutter mounting seat, the rotating shaft being provided with a shutter cloth capable of being rolled up or unrolled, and a connecting member capable of being matched with the insertion hole being arranged on a free end of the shutter cloth,
wherein the roller shutter mounting seat is provided with a locking mechanism for limiting rotation of the rotating shaft or releasing rotation of the rotating shaft.

2. The roller-shutter-type guardrail of claim 1, wherein,
the shutter mounting seat is provided with an accommodating cavity with an opening, a bottom wall of the accommodating cavity is provided with a mounting hole, and one end of the rotating shaft is configured to pass through the mounting hole and extend into the accommodating cavity;
wherein the locking mechanism comprises:
a clamping tooth portion, the clamping tooth portion being arranged on an inside wall of the accommodating cavity;
a clamping member, an outer periphery of the clamping member being provided with a first clamping tooth capable of being clamped with the clamping tooth portion, the clamping member being movably sleeved on one end of the rotating shaft extending into the accommodating cavity, the clamping member being capable of moving along an axial direction of the rotating shaft, and a limiting structure being arranged between the clamping member and the rotating shaft for limiting the clamping member to rotate around a central axis of the rotating shaft;
an elastic member sleeved on an outer peripheral wall of the rotating shaft, one end of the elastic member abutting against the bottom wall of the accommodating cavity, and the other end of the elastic member abutting against the clamping member; and
a force-applying member, the force-applying member being movably mounted at the opening of the accommodating cavity, the force-applying member being capable of exerting a force on the clamping member and pushing the clamping member to be clamped with the clamping tooth portion.

3. The roller-shutter-type guardrail of claim 2, wherein,
the limiting structure comprises a clamping slot and a clamping block which are capable of being clamped with each other; and
one of the clamping slot and the clamping block is arranged on a side wall of the rotating shaft, and the other is arranged on the clamping member.

4. The roller-shutter-type guardrail of claim 1, wherein,
the shutter assembly further comprises a hollow cylinder, the cylinder is movably sleeved on an outer periphery of the rotating shaft, a space for accommodating the shutter cloth is provided between the cylinder and the rotating shaft, a side wall of the cylinder is provided with an opening for the shutter cloth to pass through, one end of the cylinder is provided with a locking portion movably passing through the mounting hole and extending into the accommodating cavity, the locking portion is provided with a locking tooth, and the clamping member is provided with a second clamping tooth capable of being engaged with or separated from the locking tooth.

5. The roller-shutter-type guardrail of claim 1, wherein,
one end of the shutter mounting seat connected with a mounting plane is detachably connected with a base, the base is provided with an insertion slot, and the shutter mounting seat is provided with an insertion plate capable of being inserted into the insertion slot.

6. The roller-shutter-type guardrail of claim 5, wherein,
a positioning structure is arranged between the shutter mounting seat and the base to limit horizontal movement and separation of the shutter mounting seat and the base.

7. The roller-shutter-type guardrail according to claim 6, wherein,
the positioning structure comprises a bolt movably mounted on a bottom portion of the shutter mounting seat and a bolt hole arranged in a surface of the base; and
an elastic pushing member capable of pushing the bolt to move towards an exterior of the shutter mounting seat is arranged inside the shutter mounting seat, and the shutter mounting seat is also provided with a pushing structure capable of enabling the bolt to retract and move towards an interior of the shutter mounting seat.

8. The roller-shutter-type guardrail of claim 7, wherein,
the pushing structure comprises:
a linking member movably mounted inside the shutter mounting seat, the linking member being connected with the bolt, and the linking member being provided with an inclined guide plane; and
a pressing member movably mounted inside the shutter mounting seat, one end of the pressing member extending out of the shutter mounting seat, and the other end of the pressing member being capable of pressing the inclined guide surface and enabling the linkage member to drive the bolt to retract and move towards the interior of the shutter mounting seat synchronously.

9. The roller-shutter-type guardrail of claim 1, wherein,
two shutter fixing seats are provided, and two ends of the connecting member are inserted into the insertion holes of the two shutter fixing seats in one-to-one correspondence.

10. The roller-shutter-type guardrail of claim 9, wherein,
one end of the connecting member is provided with a movable ejector head capable of extending outwardly or retracting inwardly, and the movable ejector head is inserted into the insertion hole of one of the shutter fixing seats; and
wherein a pushing member is movably mounted on the shutter fixing seat with the movable ejector head inserted, one end of the pushing member is configured to extend out of the shutter fixing seat, and the other end of the pushing member is configured to extend into the insertion hole.
